(19) United States
(12) Patent Application Publication
(10) Pub. No.: US 2026/0087373 A1
(43) Pub. Date: Mar. 26, 2026

(54) METHOD, APPARATUS, DEVICE, AND MEDIUM FOR PROCESSING DATA OF MACHINE LEARNING MODEL

(71) Applicant: Beijing Zitiao Network Technology Co., Ltd., Haidian District (CN)

(72) Inventors: Songwei Liu, Beijing (CN); Fangmin Chen, Beijing (CN)

(21) Appl. No.: 19/297,297

(22) Filed: Aug. 12, 2025

(30) Foreign Application Priority Data
Sep. 24, 2024 (CN) 202411336681.9

(51) Int. Cl. G06N 3/10

(52) U.S. Cl. CPC G06N 3/10

(57) ABSTRACT

A method, a device, and a medium for processing data of a machine learning model are provided. A set of data samples associated with a machine learning model is received. The machine learning model includes a plurality of network blocks, the data of the machine learning model includes first data and second data of a network block of the plurality of network blocks. A data sample of the set of data samples is input to the machine learning model to determine a first full-precision representation of the first data and a second full-precision representation of the second data of the network block respectively. A loss function is determined based on the first full-precision representation, the second full-precision representation, a first compressor having a first compression parameter, and a second compressor having a second compression parameter. Based on the loss function, the first and second compression parameters are updated.

### CROSS REFERENCE

This application claims priority to Chinese Application No. 202411336681.9, filed on Sep. 24, 2024 and entitled “METHOD, APPARATUS, DEVICE, AND MEDIUM FOR PROCESSING DATA OF MACHINE LEARNING MODEL”, the entirety of which is incorporated herein by reference.

### FIELD

Example implementations of the disclosure generally relate to machine learning, and in particular to a method, an apparatus, a device, and a computer-readable storage medium for processing data of a machine learning model.

### BACKGROUND

Machine learning technology has been widely used for a variety of tasks. As the complexity of the task increases, the number of resources occupied by the machine learning model is correspondingly increased. Various quantization techniques have been proposed to compress various data in the machine learning model. The existing hardware platform only supports quantized data in a fixed format, however, in an actual application environment, it is expected that quantization formats of various data in the machine learning model may be set according to a configuration of the actual application environment, thereby improving the performance of the machine learning model.

### SUMMARY

In a first aspect of the disclosure, a method for processing data of a machine learning model is provided. In the method, a set of data samples associated with a machine learning model is received, the machine learning model includes a plurality of network blocks, the data of the machine learning model includes first data and second data of a network block of the plurality of network blocks, the first data includes weight data of the network block, and the second data includes activation data of the network block. A data sample of the set of data samples is input to the machine learning model to determine a first full-precision representation of the first data and a second full-precision representation of the second data of the network block, respectively. A loss function is determined based on the first full-precision representation, the second full-precision representation, a first compressor, and a second compressor. The first compressor has a first compression parameter and is configured to compress the first full-precision representation, and the second compressor has a second compression parameter and is configured to compress the second full-precision representation. Based on the loss function, the first compression parameter and the second compression parameter are updated.

In a second aspect of the disclosure, an apparatus for processing data of a machine learning model is provided. The apparatus includes: a receiving module configured to receive a set of data samples associated with the machine learning model, the machine learning model including a plurality of network blocks, the data of the machine learning model including first data and second data of a network block of the plurality of network blocks, the first data including weight data of the network block, and the second data including activation data of the network block; an input module configured to input a data sample of the set of data samples to the machine learning model to determine a first full-precision representation of the first data and a second full-precision representation of the second data of the network block, respectively; a determining module configured to determine a loss function based on the first full-precision representation, the second full-precision representation, a first compressor, and a second compressor, the first compressor having a first compression parameter and configured to compress the first full-precision representation, and the second compressor having a second compression parameter and configured to compress the second full-precision representation; and an updating module configured to update the first compression parameter and the second compression parameter based on the loss function.

In a third aspect of the disclosure, an electronic device is provided. The electronic device includes: at least one processor; and at least one memory coupled to the at least one processor and storing instructions for execution by the at least one processor. The instructions, when executed by the at least one processor, cause the electronic device to perform the method according to the first aspect of the disclosure.

In a fourth aspect of the disclosure, there is provided a computer-readable storage medium having stored thereon a computer program which, when executed by a processor, causes the processor to implement the method according to the first aspect of the disclosure.

In a fifth aspect of the disclosure, there is provided a computer program product, including a computer program. The computer program, when executed by a processor, implements the method according to the first aspect of the disclosure.

It should be understood that the content described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an example implementation of the disclosure;

FIG. 2 shows a block diagram of data for processing a machine learning model according to some implementations of the disclosure;

FIG. 3 shows a block diagram of impact on quantization performance of various network blocks in a machine learning model according to some implementations of the disclosure;

FIG. 4 shows a block diagram for correcting an output of a network block of a machine learning model according to some implementations of the disclosure;

FIG. 5 shows a block diagram of an attention map of a network block according to some implementations of the disclosure;

FIG. 6 shows a block diagram of an optimization target according to some implementations of the disclosure;

FIG. 7A shows a block diagram of a portion of an inference process according to some implementations of the disclosure;

FIG. 7B shows a block diagram of another portion of an inference process according to some implementations of the disclosure;

FIG. 8 shows a block diagram of a network module according to some implementations of the disclosure;

FIG. 9 shows a block diagram of a comparison of a multiplication process performed with a solution with padding and a solution without padding according to some implementations of the disclosure;

FIG. 10 shows a block diagram of eliminating bank conflicts according to some implementations of the disclosure;

FIG. 11 shows a block diagram of a computing line according to some implementations of the disclosure;

FIG. 12 shows a block diagram of a computing line according to some implementations of the disclosure;

FIG. 13 shows a flowchart of a method for processing data of a machine learning model according to some implementations of the disclosure;

FIG. 14 shows a block diagram of an apparatus for processing data of a machine learning model according to some implementations of the disclosure; and

FIG. 15 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The terms “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and user authorization obtaining process is merely illustrative, and does not constitute a limitation on implementations of the disclosure, and other manners of meeting related laws and regulations may also be applied to implementations of the disclosure.

The term “in response to” as used herein means a state in which a respective event occurs or a condition is satisfied. It will be appreciated that the timing of execution of a subsequent action performed in response to the event or the condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

Machine learning technology has been widely used for a variety of tasks. As the complexity of the task increases, the number of resources occupied by the machine learning model is correspondingly increased. Various quantization techniques have been proposed to compress various data in the machine learning model. The existing hardware platform only supports quantized data in a fixed format, however, in an actual application environment, it is expected that quantization formats of various data in the machine learning model may be set according to a configuration of the actual application environment, thereby improving the performance of the machine learning model.

FIG. 1 is a block diagram 100 of an application environment according to some implementations of the disclosure. As shown in FIG. 1, the machine learning model 110 may include a plurality of network blocks 112, 114, . . . , and 116, which are connected in an order of a line to process data and output corresponding results. The network block may have one or more layers, and the accuracy of the data of the network block may be set. For example, data 120 in the network block 114 may be represented in a full-precision format, at which time a large amount of computing resources and storage resources will be occupied. Especially for the machine learning model for executing a natural language processing task, the model complexity is extremely high. If the data in respective network blocks is stored in the full-precision format, significant resource overhead and unacceptable processing time delay will be caused.

Quantization techniques have been proposed to compress data in a machine learning model. A language model (e.g., a large language model) has become a main model of natural language processing, however the actual application thereof will occupy huge storage resources and computing resources. The post-training quantization (PTQ) technology has become an effective means of accelerating the inference process of the machine learning model. Although the PTQ is increasingly popular in model compression, the actual deployment thereof faces huge challenges. As shown in FIG. 1, for the data 120, a quantizer 132 may be utilized to quantize data represented with high precision 130 to data represented with low precision 134. According to some implementations of the disclosure, “compression” and “quantization” may be used interchangeably.

Low-level quantization under limited computing resource conditions leads to reduced precision, and existing quantization inference frameworks cannot support efficient computation of arbitrary precision combinations. Existing hardware platforms only provide INT4/INT8 tensor cores to support W4A4/W8A8 operations, and the problem of GEMV (General Matrix Vector Multiplication) problem leads to limited computation density in the implementation of tensor cores, and cannot make full use of the maximum benefit of model quantization. In the context of the disclosure, “W” represents weight and “A” represents activation. Thus, W4A4 represents 4-bit weight and 4-bit activation, and W8A8 represents 8-bit weight and 8-bit activation, and so on.

In an existing quantization technical solution, WA full quantization is implemented by scaling activation values and abnormal values, which correspondingly increases a range fluctuation of the weight, thereby making the quantization of the weight more sensitive. In another existing technical solution, quantization is optimized by scaling the weights, which significantly increases the diversity of activations and aggravates the activation quantization problem. The above existing technical solution manually sets a scale balance factor between the activation and the weight, and cannot accurately perfect balance between the activation and the weight. At this time, it is expected that the data in the machine learning model may be processed in a more flexible and effective manner, so as to implement data compression when the accuracy of the model is maintained, thereby improving the performance of the machine learning model.

### Summary of Data Processing

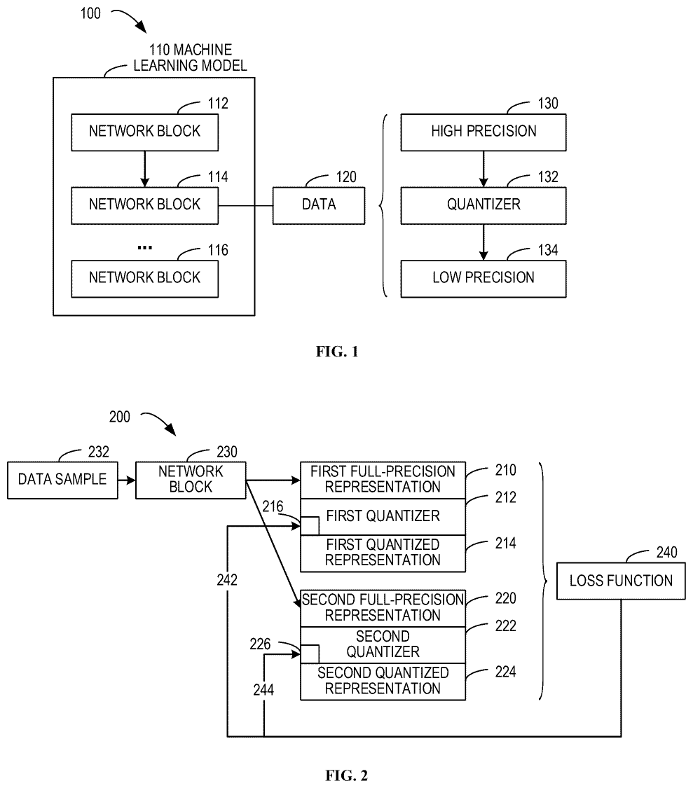

In order to at least partially solve the deficiencies in the prior art, according to an example implementation of the disclosure, a method for processing data of a machine learning model is provided. Referring to FIG. 2, a schematic diagram of an example implementation of the disclosure is described, and FIG. 2 shows a block diagram 200 of data for processing a machine learning model according to some implementations of the disclosure. As shown in FIG. 2, a set of data samples associated with the machine learning model may be received. These data samples may be determined from the training data of the machine learning model. Here, it is not necessary to use all training data to determine compression parameters, but instead the compression parameters of a compressor may be solved using only a small number (e.g., 128, or other number) of sample data.

Here, the machine learning model may include a plurality of network blocks. For ease of description, the disclosure describes a specific process of processing the data related to the network block 230 by using the network block 230 only as an example. The data of the machine learning model may include first data and second data of a network block of the plurality of network blocks, the first data includes weight data of the network block, and the second data includes activation data of the network block. In the uncompressed case, both the first data and the second data are represented in full precision, which leads to larger storage resources and overhead of computing resources.

In order to solve the above problems, a machine learning model quantization and acceleration solution is proposed. Specifically, a data sample of the set of data samples may be input to the machine learning model to determine a first full-precision representation of the first data and a second full-precision representation of the second data, respectively, of the network block. As shown in FIG. 2, a first compressor (e.g., a first quantizer 212) may be utilized to transform the first full-precision representation 210 of the first data into a first compressed representation (e.g., a first quantized representation 214). Similarly, a second compressor (e.g., a second quantizer 222) may be utilized to transform the second full-precision representation 220 of the second data into a second compressed representation (e.g., a second quantized representation 224).

A loss function is determined based on the first full-precision representation, the second full-precision representation, the first compressor, and the second compressor. The first compressor has a first compression parameter and is configured to compress the first full-precision representation, and the second compressor has a second compression parameter and is configured to compress the second full-precision representation. Based on the loss function, the first compression parameter and the second compression parameter is updated. Specifically, the first quantizer 212 has a first compression parameter 216 and the second quantizer 222 has a second compression parameter 226. Respective compression parameters may be determined by solving the loss function 240.

According to some implementations of the disclosure, individual data samples of a set of data samples may be processed in a similar manner, thereby progressively determining compression parameters that are more suitable (i.e., producing less loss). With some implementations of the disclosure, the weight data and the activation data of the compression parameter may be determined in a unified manner. In this way, the data in the machine learning model may be processed in a more flexible and effective manner, so as to implement data compression without maintaining the model accuracy, thereby improving the performance of the machine learning model.

### Detailed Process of Data Processing

Having described a summary according to some implementations of the disclosure, more details of determining compression parameters will be described below. For ease of description, a language model will be described below only as an example of the machine learning model, and relevant data compression process performed for the natural language data is described. Here, the language model may perform various tasks, such as abstract determination, translation, language style conversion, and the like. Alternatively and/or additionally, the machine learning model may include a model for performing other tasks, such as an image processing model, an audio processing model, a video processing model, or the like.

According to some implementations of the disclosure, the first compressor is determined based on the first compression parameter, a scaling factor, and a first width for indicating a first compressed representation of the first data, and the second compressor is determined based on the second compression parameter, a scaling factor, and a second width for indicating a second compressed representation of the second data. With some implementations of the disclosure, the data compression process may be transformed into a mathematical solution process, so that individual compression parameters may be determined in a simpler and efficient manner.

The meaning of various symbols involved in the data compression process is described first. According to some implementations of the disclosure, p represents a width of a weight (i.e., the weight is represented by using p bits), q represents a width of activation (i.e., the activation is represented by using q bits), W represents a weight of full-precision, and X represents full-precision activation. Alternatively and/or additionally, meanings of p and q may be exchanged, at which time p represents the width of activation and q represents the width of weight.

According to some implementations of the disclosure, a clipping function clip( ) may be utilized to extract data from the full-precision representation, and the clipping function may have a clipping range. Further, the clipped data may be represented as a binary representation having a respective width, thereby determining a compressed representation.

According to some implementations of the disclosure, in the process of determining the loss function, the first compressed representation may be determined based on the first compressor and the first compression parameter, and the first compression parameter represents a first clipping range of the first compressor. The second compressed representation is determined based on the second compressor and the second compression parameter, and the second compression parameter represents a second clipping range of the second compressor. Further, the loss function may be obtained based on the first full-precision representation, the second full-precision representation, the first compressed representation, and the second compressed representation.

In particular, a compressor Q( ) may be utilized to determine a compressed representation of weight within a clipping range (e.g., clip (W)), and another compressor Q( ) may be utilized to determine a compressed representation of activation) within a clipping range (e.g., clip (X). Further, a difference between two computation results may be determined based on computation results of full-precision representations of various data and computation results of the compressed representations of various data, and then the loss function is determined. With some implementations of the disclosure, the process of solving the compression parameter may be transformed into a mathematical process, thereby improving the data processing efficiency.

According to some implementations of the disclosure, in the process of determining the loss function, a full-precision output of the network block may be determined based on the first full-precision representation and the second full-precision representation; a compressed output of the network block is determined based on the first compressed representation and the second compressed representation; and a loss function is obtained based on a difference between the full-precision output and the compressed output. Specifically, in order to solve the above problem, the disclosure provides a method for distributing and guiding aware scaling. Specifically, balance vectors between weights and activations are set as learnable parameters, and learnable clipping parameters are added to the weights. The model performance is optimized by using distribution correction and bit-balancing strategies. The optimization objective is as follows:

$${arg min}_{s , α , β} ‖ WX - Q ( clip ( W ) \cdot diag ( s ) ) Q ( {diag ( s )}^{- 1} \cdot X ) ‖ \qquad formula 1$$

In the above formula, W represents the full-precision weight, X represents the full-precision activation, Q( ) represents a quantizer of weight and activation, clip( ) represents a clipping operation, s represents a scaling factor, and α,β represents a learnable clipping parameter for facilitating to control a clipping range of abnormal values of the weights. By setting the balance vector between the weight and the activation as the learnable parameter and solving the formula 1, the numerical value of α,β may be determined in a uniform manner, thereby achieving the full quantization process of weight and activation.

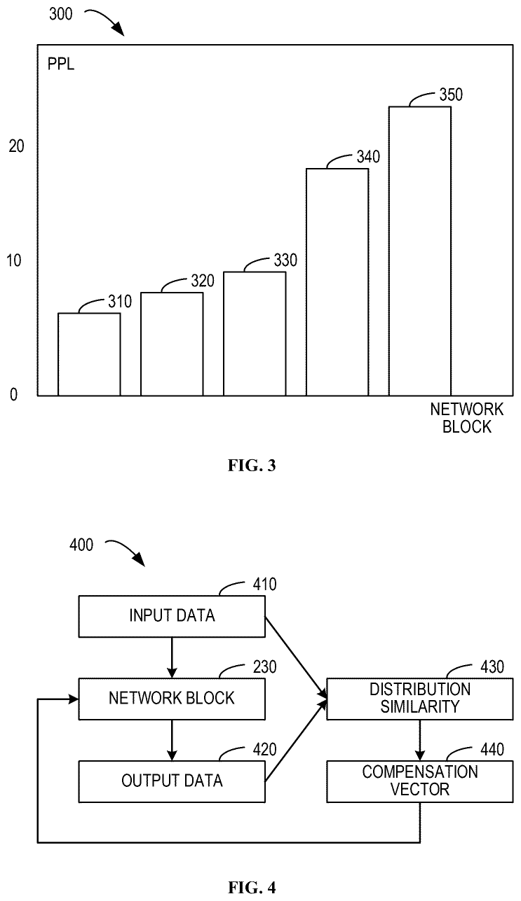

It should be understood that in the process of quantizing the model, the sensitivity of different layers in the model is significantly different, and some layers have a decisive effect on the quantization performance. The impact of various network blocks on quantization performance is described with reference to FIG. 3. FIG. 3 shows a block diagram 300 of impact on quantization performance of various network blocks in a machine learning model according to some implementations of the disclosure. As shown in FIG. 3, the abscissa represents different network blocks in the model, and the ordinate represents related perplexity (PPL) of the network block. The perplexity is an important index for evaluating the performance of the language model, which measures the prediction capability of the model on the test data. The lower the perplexity, the more accurate the prediction of the model on the data is, that is, the higher the prediction accuracy of the model for the probability of occurrence of the word sequence in the test set.

FIG. 3 shows that different components in a transformer block (i.e., a network block) in a language model are quantized in a scenario of weight-activation full quantization. As shown in FIG. 3, block 310 represents a related quantization impact of a FP16 (16-bit floating point number) model, block 320 represents a related quantization impact of attention, block 330 represents a related quantization impact of attention, gate projection (gate_proj), and up-projection (up_proj), block 340 represents a related quantization impact of attention and down-projection (down_proj); and block 350 represents a related quantization impact of a INT4 (4-bit integer) model. When a gate projection layer and an up-projection layer in the attention layer and the MLP are quantized, the model performance is only slightly degraded. However, when quantizing a down-projection layer, the model performance is significantly degraded, indicating that the processing of quantization of the layer is a key difficulty affecting performance.

Further, the main reason for performance degradation caused by the quantization of the down-projection linear layer is the quantification of the activation of the down-projection. In the case of low bits such as INT4, INT3, and INT2, since the representation range is limited, the distribution of the quantized model is significantly offset from the model distribution under the full-precision representation. Based on the foregoing observation results, the disclosure provides a solution of correcting an output of a network block.

Further details of the correction process are described with reference to FIG. 4, which shows a block diagram 400 for correcting an output of a network block of a machine learning model according to some implementations of the disclosure. As shown in FIG. 4, a similarity (i.e., a distribution similarity 430) between distribution of input data 410 of the network block 230 and distribution of output data 420 of the network block 230 may be determined. In response to determining that the similarity satisfies a predetermined condition (e.g., below a predetermined threshold), a compensation vector 440 for compensating the output may be determined, and then parameters of the network block are updated based on the compensation vector 440, thereby achieving the objective of correcting the output data 420.

According to some implementations of the disclosure, during the quantization correction process, a double cosine similarity loss may be established for the output of the layer of the down-projection layer to correct the output distribution of the down-projection layer in the quantized model. The specific loss function is as follows:

$${ℒ}_{DLC}^{i} = - log ( \frac{{d}_{q}^{i} \cdot {d}_{fp}^{i}}{‖ {d}_{q}^{i} ‖ ‖ {d}_{fp}^{i} ‖} ) - log ( \frac{{d}_{q}^{i} \cdot {d}_{{fp}^{*}}^{i}}{‖ {d}_{q}^{i} ‖ ‖ {d}_{{fp}^{*}}^{i} ‖} ) \qquad formula 2$$

In the above formula,

$${d}_{q}^{i}$$

represents the quantized output of the i-th transformer block,

$${d}_{fp}^{i}$$

represents the full-precision output of the i-th transformer block;

$${d}_{{fp}^{*}}^{i}$$

presents the full-precision output of the i-th transformer block, but the input thereof comes from the quantized output of the (i−1)-th transformer block. With some implementations of the disclosure, the output of a network block with a large difference between a input data distribution and an output data distribution may be corrected. In this way, the influence of the quantization process on the accuracy of the network block can be reduced, thereby improving the accuracy of the entire machine learning model.

The disclosure further analyzes the changes in the input and output cosine similarity of activation values in the model pass after passing through a decoder block. The observation results show that there is a significant difference in the cosine similarity of activation inputs and outputs of multiple blocks at the head and tail of the model, which indicates that these head and tail blocks have a great influence on the inference performance of the model. According to some implementations of the disclosure, in the process of updating the output, in response to determining that the network block is a network block of the plurality of network blocks located at a head position or a tail position, an output of the network block is updated based on the compensation vector. With some implementations of the disclosure, network blocks that may produce larger perplexity may be prioritized for processing, thereby improving the accuracy of the machine learning model.

According to some implementations of the disclosure, in the process of updating the output by using the compensation vector, the compensation vector may be used to update the weight data of the network block, and the updated output is determined based on the updated weight data. For this phenomenon, vector distribution compensation may be applied to the down-projection layer of the head and tail blocks to compensate for distribution differences between the blocks. The specific formula is as follows:

$${W}_{q} = clamp ( ⌈ \frac{W + β {ab}^{⊤}}{△} ⌉ + z , 0 , {2}^{n} - 1 ) \qquad formula 3$$

In the above formula, ┌·┘ represents the operation of rounding to the nearest value, n represents the number of bits, Δ represents the step size, z represents the zero point, W_{q} represents the quantized weight, W represents the full-precision weight, a, b represents the distribution compensation vector, b is used for controlling whether compensation is performed, b=1 represents that compensation is performed, and b=0 represents that compensation is not performed. With some implementations of the disclosure, the quantized weight of the network block may be updated by a function of clamp( ). In this way, the corrected quantization output may be consistent with the distribution of the input, thereby reducing the influence of the quantization process on the perplexity of the network block, thereby improving the accuracy of the machine learning model.

According to some implementations of the disclosure, the distribution changes of the attention map before and after quantization may be observed, so as to further improve the performance of the quantization model. FIG. 5 shows a block diagram 500 of an attention map of a network block according to some implementations of the disclosure. The abscissa and the ordinate of each coordinate system in FIG. 5 represent the tokens in the network block, and the color gray represents the attention related to the two tokens at the intersection of the abscissa and the ordinate. Only the attention between tokens of 0 to 15 is shown in the figure, in which the dark color indicates that the attention is 1.0, and the light color indicates that the attention is 0.0.

As shown in FIG. 5, block 510 shows a related attention map of the full-precision model. In the full-precision model, a large amount of attention is focused on the first token of the sequence, which indicates that the first token plays a key guiding role in the text generation process. Block 520 shows a relevant attention map of the quantization model. However, the attention distribution of the quantized model changes significantly, and the attention of the text sequence on the first token is interfered.

In order to solve this problem and restore the attention of the model to the first token in the quantization process, the attention-aware KL divergence is introduced to reconstruct the attention distribution of the attention map. According to some implementations of the disclosure, in the process of determining the first compression parameter and the second compression parameter, the attention-aware divergence associated with the network block may be determined for the network block; and the first compression parameter and the second compression parameter are updated based on the attention-aware divergence. The specific formula is as follows:

$${ℒ}_{AKL}^{i} = {D}_{KL} ( {attn}_{q}^{i} ‖ {attn}_{fp}^{i} ) + {D}_{KL} ( {attn}_{fp}^{i} ‖ {attn}_{q}^{i} ) \qquad formula 4$$

In the above formula,

$${attn}_{q}^{i}$$

represents the quantized attention map output of the i-th transformer block, and

$${attn}_{fp}^{i}$$

represents the full-precision attention map output of the i-th transformer block. With some implementations of the disclosure, in the process of determining the compression parameter, the quantization model may be enabled to restore the attention to the first token, thereby improving the accuracy of the machine learning model. Block 530 in FIG. 5 shows the attention distribution after applying the reconstructed attention map, and at this time, the attention map for the first token (e.g., the token of “0” on the leftmost side as shown) is more similar to the attention map of the full-precision model shown at block 510.

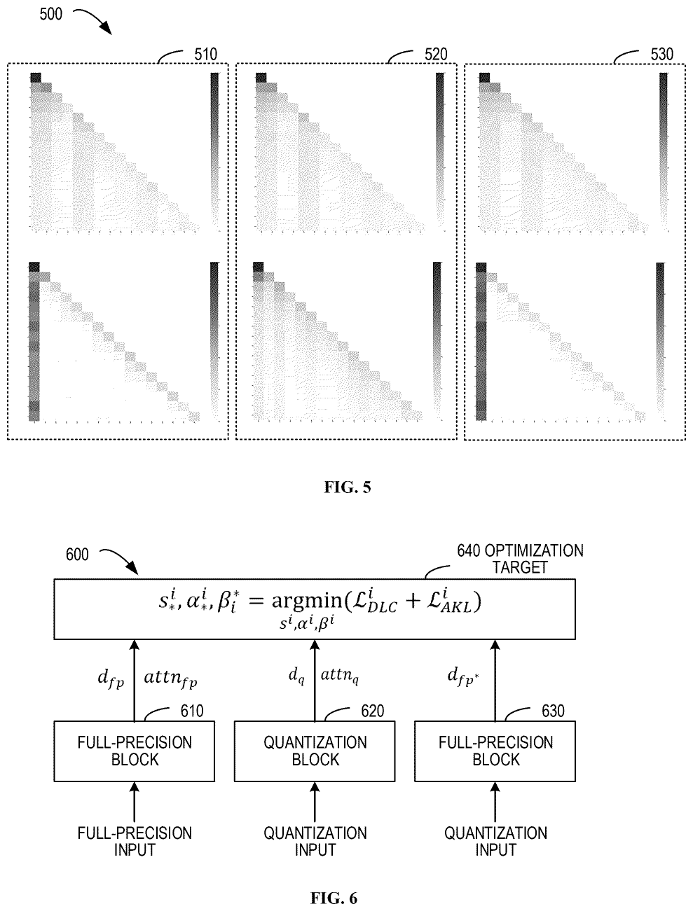

According to some implementations of the disclosure, the existing DLC loss and the AKL loss proposed by the disclosure may be combined to determine a final optimization target. Further details are described with reference to FIG. 6, which shows a block diagram 600 of an optimization target according to some implementations of the disclosure. As shown in FIG. 6, a full-precision block 610 may receive the full-precision input, a quantization block 620 may receive the quantization input, and a full-precision block may receive the quantization input. At this time, the final optimization target may be represented as:

$${s}_{*}^{i} , {α}_{*}^{i} , {β}_{i}^{*} = {arg min}_{{s}^{i} , {α}^{i} , {β}^{i}} ( {ℒ}_{DLC}^{i} + {ℒ}_{AKL}^{i} ) \qquad formula 5$$

In the above formula,

$${s}_{*}^{i} , {α}_{*}^{i} , {β}_{i}^{*}$$

is the quantization parameter of the i-th transformer block after verification. When the distributions of the quantized output and the full-precision output are matched, the overall loss is close to 0, which can effectively direct the quantization process. With some implementations of the disclosure, the accuracy of various network block can be improved, thereby improving the accuracy of the entire machine learning model.

The quantization process for various network block in the machine learning model has been described above. The network block may be set by using the first compression parameter and the second compression parameter determined according to the foregoing process, and then the inference process is performed by using the set network block. Specifically, a scaling factor s of a weight data compressor and an activation data compressor and the corresponding clipping parameters α,β may be solved based on the formula described above. Further, during inference, data input to the machine learning model may be processed using the determined weight data compressor and activation data compressor.

With some implementations of the disclosure, the quantization process may ensure that weight quantization and activation quantization are performed in a full quantization manner and ensure a balance between the two quantization. Further, the quantization process takes into account the similarity of the input data distribution and the output data distribution of the network block, and provides a corresponding output data correction solution. Further, the quantization process takes into account the special influence of the first token, thereby improving the accuracy of the quantized machine learning model from multiple aspects.

Further, the inference process may be performed using a quantization model. According to some implementations of the disclosure, during the inference process, input data of the network block may be determined based on a data item to be processed, the input data has a second width, and the weight data of the network block has the first width. At this time, in the network block of the machine learning model, the weight data is quantized to p bits, and the activation data is quantized to q bits. At this time, data in the machine learning model may be compressed, thereby reducing resource overheads of the inference process.

In the language model, most of the computation amounts and parameter accesses are concentrated in GEMM (General Matrix Multiply) or GEMV operation, especially the main computation process is decoding autoregressive. Since it is a single token generation, all of the GEMM operations are degraded into GEMV operations, the GEMV computation and access efficiency directly determines the efficiency and power consumption of model inference. However, GEMV, due to its special computation shape [M=1, K, N], relies on optimization difficulties in the field of high-performance computing (HPC). Especially in a GPU architecture with a matrix operation hardware unit of an existing hardware platform, since the M dimension of the minimum tensor core is 8, the M needs to be padded to an integer multiple of 8 during the actual computation. This leads to a large amount of computational waste. Thus, the overall computation utilization rate of the current GEMV implementation in the industry is less than 10%, and belongs to the access intensive computation.

In order to improve the GEMM/GEMV access efficiency, a quantization inference strategy is generally adopted in the model inference stage, and the mainstream solution in the current industry is to adopt a weight-only quantization, and a kernel performs an actual operation based on the inverse quantized FP16, which has a limited improvement on the performance in a high-parallel scenario.

In order to further improve the quantization inference performance, the research aims to realize simultaneous quantification of weight and activation, so that the activation access may be further reduced, and meanwhile, the quantization computation kernel of the hardware platform is adopted to compute with a higher computing power. However, existing weight and activation full quantization inferences have the following limitations. (1) Quantization matrix multiplication: Existing hardware platforms provide only a few formats of hardware acceleration instructions (W4A4, W8A8), which limits the design space of the quantization algorithm. When other quantization formats such as W4A8 and W1A3 are processed, other quantization formats need to be transformed to W8A8 and W4A4, and the efficiency is low. (2) GEMV problem: The existence of the GEMV leads to the introduction of additional padding computation in a scenario of a batch size<8, resulting in inefficient W4A4, W8A8 matrix multiplication.

According to some implementations of the disclosure, to improve inference efficiency, input data may be divided into a plurality of input matrices; based on a hardware multiplication instruction of a hardware device implementing the network block, a plurality of multiplication results associated with the plurality of input matrices are determined respectively by using a plurality of thread wraps provided by the hardware device; and a result of the inference process is determined based on the plurality of multiplication results. With some implementations of the disclosure, the inference process may be performed in a parallel manner by using hardware multiplication instructions supported by the hardware device respectively.

According to some implementations of the disclosure, by careful analysis of the quantization matrix multiplication, it is found that the operation of any quantization combination may be decomposed into a special superposition of 1-bit matrix multiplication. It is assumed that the weight W of a certain layer of the neural network is quantized into p bits, the input activation value X is quantized into q bits, and the matrix multiplication operation is performed with W, X to obtain an output of 32 bits, Y=WX. At this time, scalar values of the weights W and activation values X at arbitrary positions may both be decomposed into a series of 1-bit scalar numbers, and any precision combined scalar operation may be decomposed into 1-bit operations and shift operations. To support any precision combination operation at a scalar level, such as a scalar-level arbitrary precision computation wx with 1-bit weight w and 2-bit activation value x, format conversion may be performed first. For example, the 2-bit x may be represented as:

$$\begin{matrix}y = {x}^{1} {x}^{0} , w , {x}^{i} ∈ int 1 \\ {x}^{1} = ( x ≫ 1 ) \& 1 , {x}^{0} = ( x ≫ 0 ) \& 1\end{matrix} \qquad formula 6$$

The computation operation may be represented by using OP(a, b) where the input is 1-bit data and the output is 32 bits, and at this time, the original scalar-level arbitrary precision computation wx may be represented as:

$$wx = w * ( {x}^{1} {x}^{0} ) = OP ( w , {x}^{1} ) * 2 + OP ( w , {x}^{0} ) \qquad formula 7$$

The above process may be generalized to a matrix multiplication combination with arbitrary p bits and q bits. Given a p-bit weight matrix W and a q-bit weight matrix X, a 1-bit matrix W^{s} may be first determined, where s∈{0, 1, . . . , p−1}, and X^{t}, t∈{0, 1, . . . , q−1}.

$${w}_{i , j}^{s} = ( {w}_{i , j} ≫ s ) \& 1 , {x}_{i , j}^{t} = ( {x}_{i , j} ≫ t ) \& 1 \qquad formula 8$$

It is assumed that 1-bit matrix multiplication operation is represented as Bit Matrix Multiply Accumulate (abbreviated BMMA), the BMMA operation may be invoked by p*q to calculate a series of 1-bit matrix multiplication components:

$${Y}^{s , t} = BMMA ( {W}_{s} , {X}_{t} )$$

Finally, all 1-bit matrix multiplication components are subjected to scaling coefficient processing with bit-wise superposition, and then accumulated to obtain an output matrix of 32 bits:

$$Y = {\sum }_{s = 0}^{p - 1} {\sum }_{t = 0}^{q - 1} {Y}^{s , t} * {2}^{s + t} \qquad formula 9$$

Through the foregoing transformation process, an operation of any quantization combination may be decomposed into special superimposition of 1-bit matrix multiplications, and the BMMA instruction with high computational power may be invoked. The main gain is as follows: effectively solving the computation efficiency problem of the GEMV, and since the real M dimension is BatchSize*X_BIT during the underlying computation, BatchSize (batch size) is an integer of 8 when X_BIT=8, effectively improving the computation density. At this time, the quantization combined computation of any bit may be supported in a unified manner, so that different quantization combinations may be reasonably selected according to the model scale, and meanwhile, the underlying implementation is efficient.

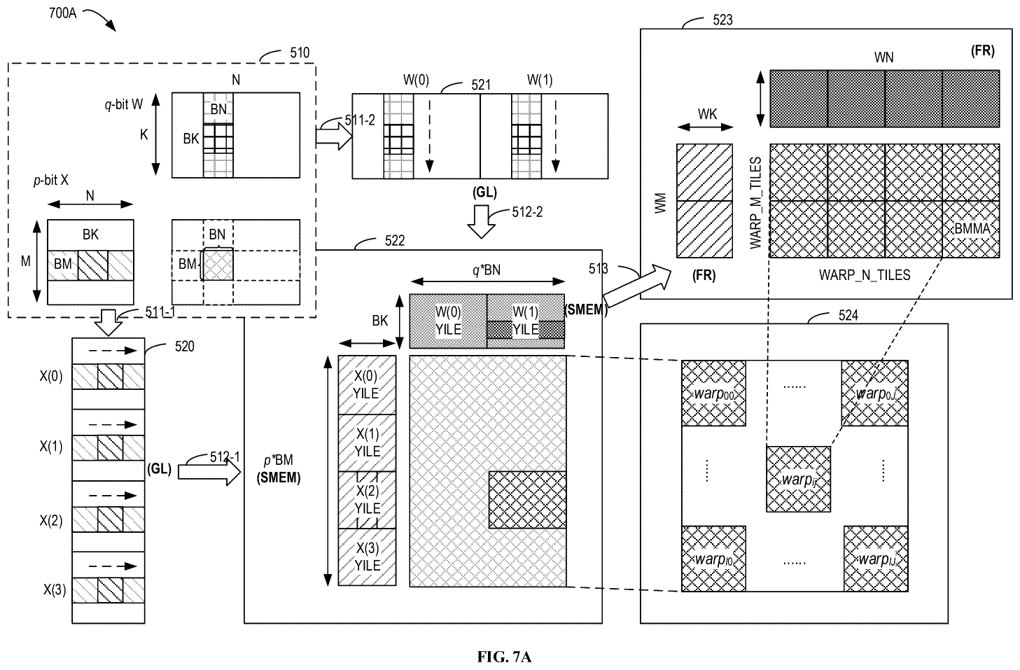

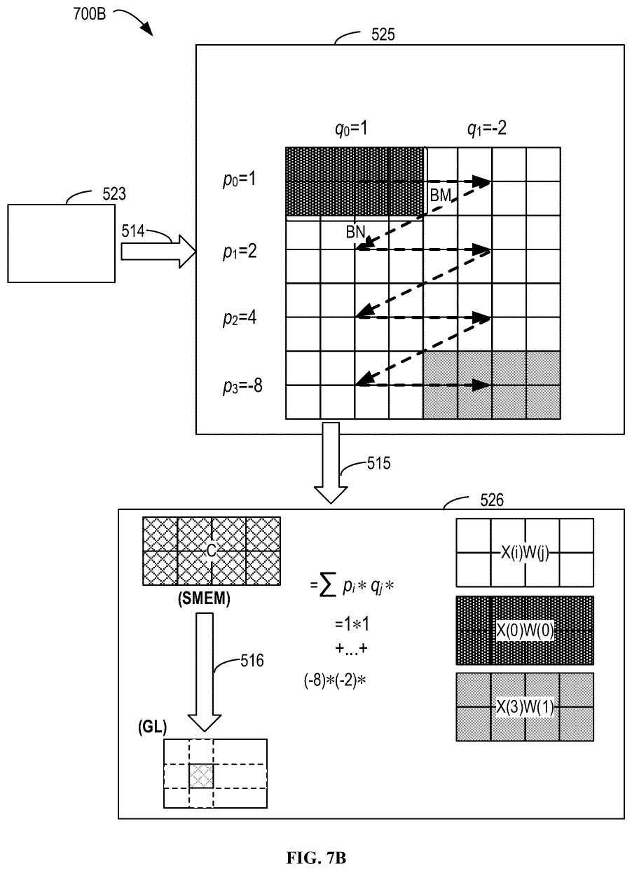

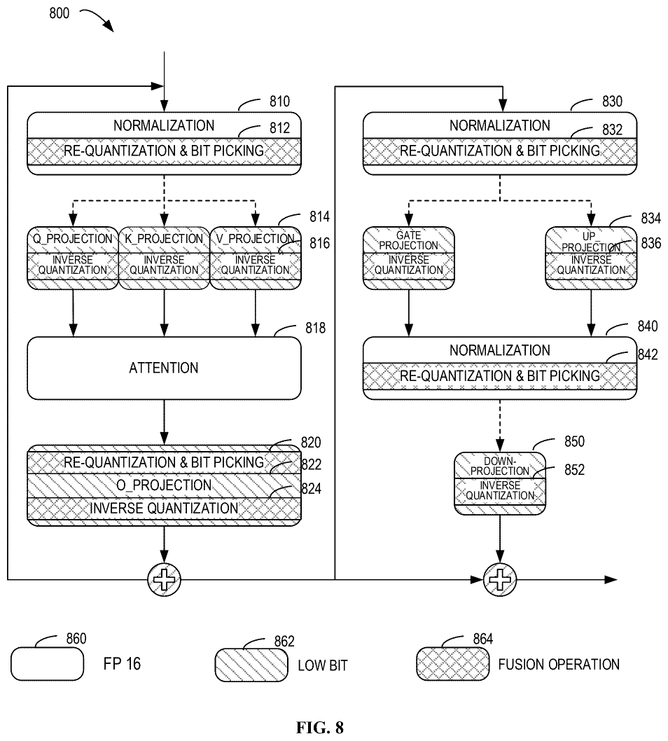

Further details regarding the inference process are described with reference to FIGS. 7A and 7B. FIGS. 7A and 7B show block diagrams 700A and 700B of a portion of an inference process according to some implementations of the disclosure. The data stream of the inference process may support efficient computation: Global Memory (GL)→Shared Memory (SMEM)→Fragment (FR)→Shared Memory (SMEM)→Global Memory (GL).

As shown in block 510 in FIG. 7A, the weight data W is represented as q bits, and the activation data X is represented as p bits. Current GPUs have multiple processing units known as Streaming Multiprocessor (abbreviated SM) and use a large number of threads to perform computing tasks in parallel. The thread is configured as a thread block, and the thread block becomes a minimum schedulable execution unit on the SM. Therefore, the computing target is decomposed and mapped to each thread block (referred to as Thread Block Tile) to implement parallel computing. As shown in FIG. 7A, for a GEMM task with a shape of M×N×K, each thread block is responsible for calculating a BM×BN output block, which is decomposed into K/BK sub-GEMM tasks with a shape of BM×BN×BK. In the disclosure, quantization matrix multiplication of bit width configuration {p, q} is transformed to a special accumulation of p*q binary matrix multiplication. At this time, the real computing task of the thread block tile is p*BM×q*BN.

First, as shown by arrows 511-1 and 511-2, in order to improve the continuity of storage access, a BitPacking strategy is proposed. As represented by block 510, the quantized tensor is decomposed into n binary matrices, where n is the quantization bit width. Taking the input X as an example, this means that its storage layout changes from [M, K, p] to [p, M, K] from the bit perspective. All threads within a thread block share the same shared memory space. Within each thread block, the threads are further organized into a set of thread wraps, each wrap including 32 consecutive threads.

Second, as shown by arrows 512-1 and 512-2, the wrap coordinates the loading of the A matrix (p*BM×BK) and B matrix (BK×q*BN) data required for thread block tile 522 computation from the GL 521 and buffers them in the SMEM. Based on bit picking, the process of reading a single-bit row-major tile of pBM*BK and writing p*BM*BK bits to SMEM is efficient and continuous.

Third, as shown by the arrow 513, since the thread block includes a plurality of wraps, the thread block tile may be further decomposed into a wrap tile 523, to implement the wrap-level parallel processing, and the computing task of each wrap is WM×WN. In the computation preparation stage, the A matrix (WM×WK, row-major) and B matrix (WK×WN, col-major) are independently loaded from SMEM to FR, and the computation is then decomposed into WRAP_M_TILES*WRAP_N_TILES tensor cores MMA (matrix-multiply-accumulate). Since A and B are binary matrices, a binary tensor core MMA (BMMA) is actually used, and the computing power is respectively increased by 8 times and 4 times than the INT8 and INT4 tensor cores. Here, the layout of the thread wraps is represented by block 524.

Fourth, with continued reference to FIG. 7B, FIG. B shows a block diagram 700B of another portion of an inference process according to some implementations of the disclosure. According to some implementations of the disclosure, for an input matrix among a plurality of input matrices, a hardware multiplication instruction is executed with a thread wrap of a plurality of thread wraps to determine a multiplication result associated with the input matrix; and the multiplication result is written into a storage area of the hardware device corresponding to the thread wrap. Specifically, as shown by arrow 524, the wrap tile 523 is processed and the computation result is written to the shared memory 525. All wraps cooperate to complete the computation of the thread block tiles, and the results are stored in c fragments of each wrap. Thus, each wrap needs to write the computation result back to the SMEM individually. With some implementations of the disclosure, respective input matrices may be processed in a parallel manner, thereby improving the inference performance of the machine learning model.

Fifth, as indicated by arrow 515, the output tile (p*BM×q*BN) is globally reduced to obtain the final result (BM×BN), where each BM×BN sub-tile needs to be multiplied by a certain scaling factor, which process may be referred to as Bit Reduction.

Sixth, as indicated by arrow 516, the wrap coordinates the loading of the final result from the SMEM and writes the final result back to the target location in the GL. According to some implementations of the disclosure, in the process of determining a result of an inference process based on a plurality of multiplication results, the plurality of multiplication results may be obtained from a plurality of storage areas corresponding to the plurality of thread wraps, respectively; and the result of the inference process is determined based on the plurality of multiplication results. Specifically, the foregoing computation process may be implemented as a GPU Kernel. As shown in FIG. 7B, the GPU kernel is used to replace all gemm operations in the decoder layer and assist in performing the necessary bit picking, quantization and inverse quantization operations to implement arbitrary quantization inference of the model. With some implementations of the disclosure, the overhead of the quantization operators is managed by fusing the quantization operators into existing operators, and bit picking of weights is performed in an offline manner to improve the efficiency.

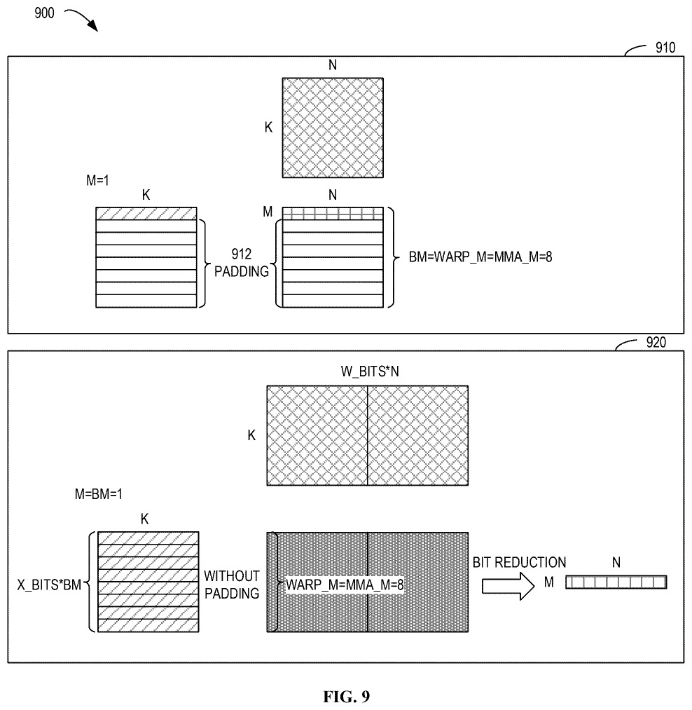

FIG. 8 shows a block diagram 800 of a network module according to some implementations of the disclosure. Specifically, FIG. 8 shows a computation graph in a transformer block of a language model. Re-quantization and inverse quantization represent online quantization and inverse quantization operations, respectively, while bit picking represents activated online layout transition. FIG. 8 shows a plurality of network layers experienced by a data stream, legend 860 represents a 16-bit floating point number, legend 862 represents a low bit format, and legend 864 represents a fusion operation. At layer 810, a normalization operation is performed. At block 812, a re-quantization and bit picking operation is performed. A Q-projection operation, a K-projection operation, a V-projection operation and related inverse quantization operations are respectively performed in three subsequent parallel branches. Taking the right-most branch as an example, the V-projection operation is performed at block 814, and the inverse quantization operation is performed on the projection result at block 816. At block 818, an attention operation is performed. At block 820, the re-quantization and bit picking operation is performed. At block 822, an O-projection operation is performed. At block 824, the inverse quantization operation is performed.

Then, at block 830, the normalization operation is performed. At block 832, the re-quantization and bit picking operation is performed. A gate projection, an up-projection operation, and related inverse quantization operations are respectively performed in subsequent two parallel branches. Taking the right-most branch as an example, an up-projection operation is performed at block 834, and the inverse quantization operation is performed on the projection result at block 836. At block 840, the normalization operation is performed. At block 842, the re-quantization and bit picking operation is performed. At block 850, a down-projection operation is performed. At block 852, the inverse quantization operation is performed. It should be understood that FIG. 8 merely schematically shows an example of a workflow, alternatively and/or additionally, based on a particular application environment, the machine learning model may include more, fewer, or different layers.

It should be understood that most of the computation and parameter accesses in the language model are concentrated in the GEMM/GEMV operation, and the GEMV of the decoding stage is an important performance bottleneck. The GEMV/GEMM operation may be represented using M, N, K, where sizes of two multiplication matrices is M×K and K×N. When M=1, the GEMM problem may be transformed to a GEMV problem, while operators may transition from compute-intensive type to access intensive type.

According to some implementations of the disclosure, the input data may be divided into a plurality of input matrices based on parallel configuration information of the hardware device. In order to perform acceleration computation by using tensor cores, blocking is usually performed along the M dimension according to BM=8, and if M<8, 0 padding is applied, resulting in redundant computation. According to any precision quantization inference based on BTC, a matrix is decomposed into a plurality of single-bit matrix components, and a plurality of single-bit GEMV questions are transformed back to the GEMM problem, reducing or even avoiding the redundant computation caused by padding while utilizing tensor cores.

More details are described with reference to FIG. 9, FIG. 9 shows a block diagram 900 of a comparison of a multiplication processes performed with a solution with padding and a solution without padding according to some implementations of the disclosure. FIG. 9 shows an implementation of a W2A8 operator, block 910 shows a process of performing GEMV of W2A8 based on a tensor core with padding, at which point, 7 positions shown in block 912 will be padded with invalid data, and only the position shown in block 914 stores valid data related to inference. Block 920 shows a process of performing GEMV of W2A8 based on a tensor core without padding. At this time, all 8 locations store inference-related valid data. In this way, storage units in the hardware device may be more fully utilized, thereby improving the inference efficiency.

Compared to the method of padding BM to 8 and then invoking the tensor core directly, by using some implementations of the disclosure, the X matrix may be decomposed into 8 sub-matrices, assuming that M=1, BM=1, WM=MMA_M=8, and a proportion of padding decreases from 7/8=87.5% to 0%. In the case of other precision, the size of the BM may be adjusted according to the size of M, thereby reducing or even avoiding redundant computation caused by padding, and improving the utilization rate of the tensor cores.

In an automatic core search, a suitable block size is a key parameter affecting the performance of the GEMM, and before any precision (WxAy, where weight is x bits and activation is y bits) operator, performance search may be performed on different blocks, and finally, one implementation with optimal performance is started. According to some implementations of the disclosure, related performance of different division manners may be tested, and the inference process is performed in an optimal division manner. For example, test input data may be divided into a first plurality of input matrices and a second plurality of input matrices, respectively, based on parallel configuration information of the hardware device; a first performance indicator for performing the inference process based on the first plurality of input matrices is determined, and a second performance indicator for performing the inference process based on the second plurality of input matrices, respectively; and in response to determining that the first performance indicator is higher than the second performance indicator, the input data is divided into the plurality of input matrices based on a quantity of the first plurality of input matrices.

Specifically, for the classic GEMM task, for the M×N×K problem, blocking is performed at the thread block level according to BM×BN×BK. Each thread block is further blocked at the wrap level by WRAP_M×WRAP_N×WRAP K. According to the block size MMA_M×MMA_N×MMA_K of the tensor cores supported by the GPU model, three levels of block sizes may be obtained from each thread wrap, and finally the different block shapes are searched.

In the implementation of any precision (WxAy) operator, the number of bits W BITS of the weight and the number of activation bits X_BITS may be introduced, and thus the search space becomes more bulky compared to the classic GEMM. Assuming that the block size of BTC is MMA_M=8, MMA_N=8, MMA_K=128, the number of thread wraps W_WRAPS_NUM=BN× W BITS/WRAP_N of the weight is calculated, the number of thread wraps of activation X_WARPS_NUM=BMXX_BITS/WARP_M, and the total number of thread wraps 1<=X_WARPS_NUM×W_WARPS_NUM<=32.

To further reduce the search space, WARP_K=MMA_K=128 may be fixed, and the length of BK is a set {128, 256, 384, 512}. Since the maximum shared memory of a single thread block supported by hardware is limited, BM, BN, and BK cannot increase infinitely. Similarly, registers that may be used by each thread are also limited, and thus WRAP_M and WRAP_N also cannot increase infinitely. The operator of the disclosure may be measured at various block sizes, and the implementation of optimal speed is determined.

According to some implementations of the disclosure, a bank conflict (also called memory bank conflict) computation process may be implemented. To achieve high bandwidth, shared memory is divided into memory cells of the same size, referred to as banks. Threads within a thread wrap may access data in different banks simultaneously in one access request. If multiple threads simultaneously access different data in the same bank, bank conflicts will occur, which will affect the performance of the computation. When the register writes an int32 matrix of 8×8 into the shared memory, if the shared memory is a multiple of 16, the bank conflict may occur.

According to some implementations of the disclosure, the plurality of thread wraps share a plurality of banks in the storage area of the hardware device. Further, some banks in the storage area may be padded such that multiple thread wraps may access multiple banks without access conflicts in parallel. Specifically, a first input matrix associated with a first thread wrap of the plurality of thread wraps is written into a first bank of the plurality of banks; a bank following the first bank is padded; a second input matrix associated with a second thread wrap of the plurality of thread wraps is written into a second bank following the bank, no access conflict exists between the first bank and the second bank.

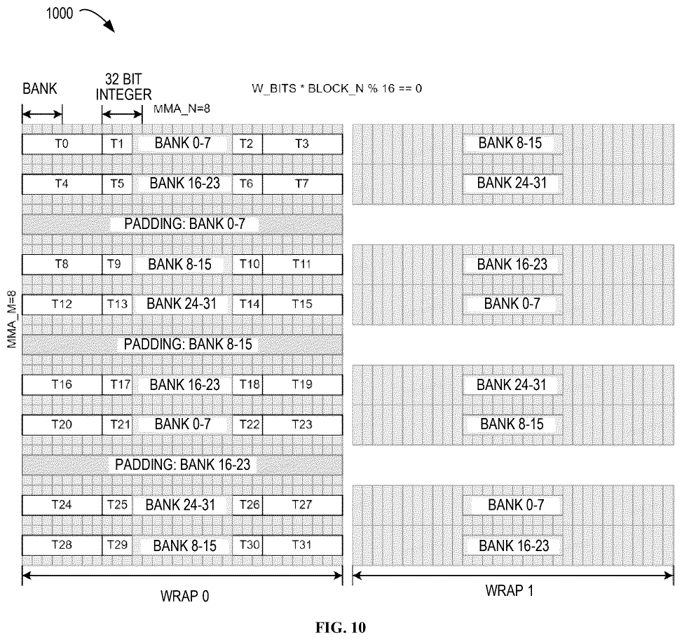

More details are described with reference to FIG. 10, FIG. 10 shows a block diagram 1000 of eliminating bank conflicts according to some implementations of the disclosure. As shown in FIG. 10, the left side shows a block diagram of one thread wrap (e.g., a wrap 0) accessing the bank, and the right side shows a block diagram of another thread wrap (e.g., a wrap 1) accessing the bank.

As shown in FIG. 10, each thread may write 2 int32 data into the shared memory, if no data is padded, the threads T0-T3 access banks 0-7, threads T4-T7 access banks 16-23, and threads T8-T11 access banks 0-7, and at this time, the bank conflict occurs. By padding 8 INT32 after every 16 int32, threads T8-T11 may be caused to access banks 8-15, and threads T12-T15 access banks 24-31. Eventually, in half a thread wrap, different threads will access different banks, avoiding the bank conflicts.

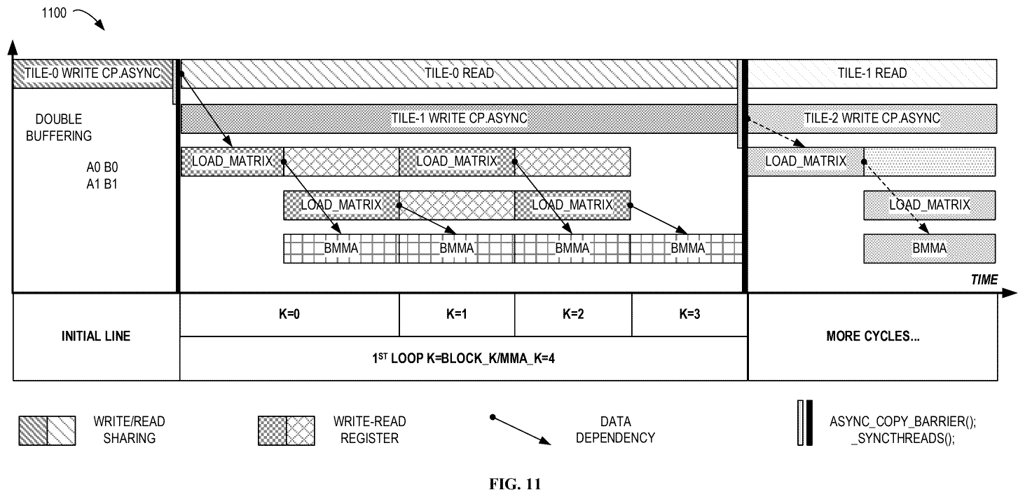

More details are described with respect to the optimization of the computing line, see FIG. 11. FIG. 11 shows a block diagram 1100 of a computing line according to some implementations of the disclosure. FIG. 11 shows a timing diagram for computing line optimization in an ampere architecture. As shown in FIG. 11, under certain architectures, at the shared memory level, writing from global memory to shared memory may be performed asynchronously by an asynchronous instruction. Before processing a first cycle, synchronization is issued to ensure that data TILE-O required by the first cycle has been ready in the shared memory. During processing of the first cycle, data TILE-1 required for a second cycle may be written to the shared memory. Thus, access time-consuming required for the shared memory in the second cycle is masked during the computation the first cycle.

At the register level, when k=0, TILE-O data of the shared memory is loaded into a first set of registers A0, B0. Data required for k=1 may also be preloaded into registers A1, B1. After data of the registers A0 and B0 are ready, A0 and B0 may be computed by invoking the Bit Matrix Multiply Accumulate. When k=1, the data A1 and B1 required by BMMA have been preloaded at k=0, at which point data required for k=2 is preloaded to the registers A0, B0. The process is repeated in this manner to enable writing data from the shared memory to the register while the BMMA computation is performed, thereby masking the access time-consuming for the register at the time of BMMA computation.

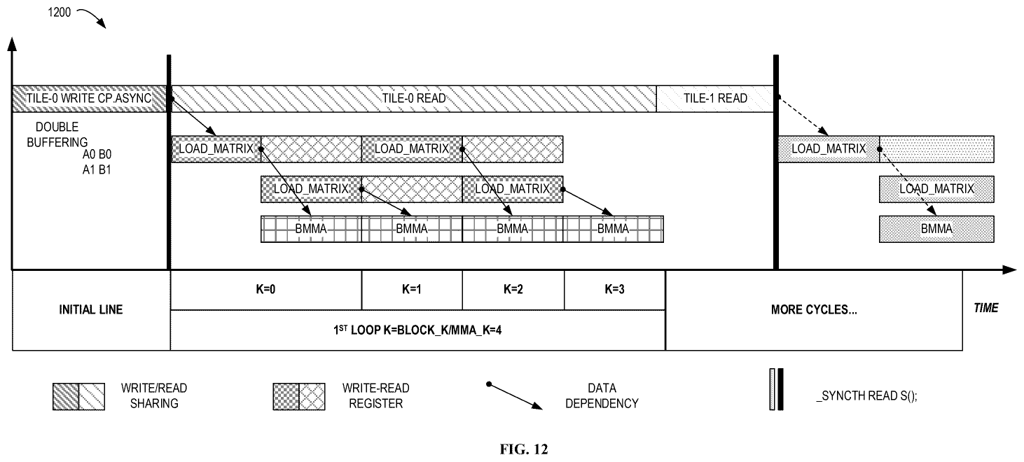

Referring to FIG. 12, a timing diagram of a line optimization process in a Turing architecture is described. FIG. 12 shows a block diagram 1200 of a computation line according to some implementations of the disclosure. As shown in FIG. 12, in some architectures, asynchronous reading/writing of the shared memory cannot be implemented by asynchronous instructions, but double buffering computation is still implemented at the register level, and access time overhead may be masked.

With some implementations of the disclosure, the effect is particularly significant when performing the quantization process, especially when using very low bit quantization. In this way, a large model may be supported to achieve higher performance on existing hardware platforms. For example, the language model may be distributed and corrected and the bit balance strategy may be performed under the quantization configuration of W2A8, so that the PPL of 9.86 (reduced by 5.66 compared with the existing solution), the kernel is improved by 5 times compared with the existing W8A8 solution, and the end-to-end throughput has achieved 1.6 times acceleration compared with the existing W8A8 solution, and the like. With some implementations of the disclosure, each indicator is better than an existing PTQ.

In the context of the disclosure, the proposed technical solution may achieve higher performance under various quantization configurations, and realize efficient arbitrary bit computation at an inference level. Specifically, the solution may achieve the following objectives. (1) Efficient Quantization and Inference: quantization matrix multiplication of arbitrary precision combination is equivalently reconstructed based on BTC (binary tensor core, abbreviated BTC), limitation of the INT4/INT8 computation unit is eliminated. It allows the gain of compressed bit width to be transformed into actual acceleration gain, the GEMV problem is effectively avoided, and the comprehensive advantage of the quantitation model under more mixing precision (such as W2A6 and W2A8) is fully mined. (2) Distribution correction method of the transformer block is introduced to relieve the distribution difference caused by full quantization of weight and activation, thereby improving the performance of the model under the low-bit situation. (3) For an asymmetric distribution problem occurring in a very low bit (for example, 2 bits) scenario, a bit balance strategy is proposed to compensate for performance loss caused by W2 quantization.

### Example Process

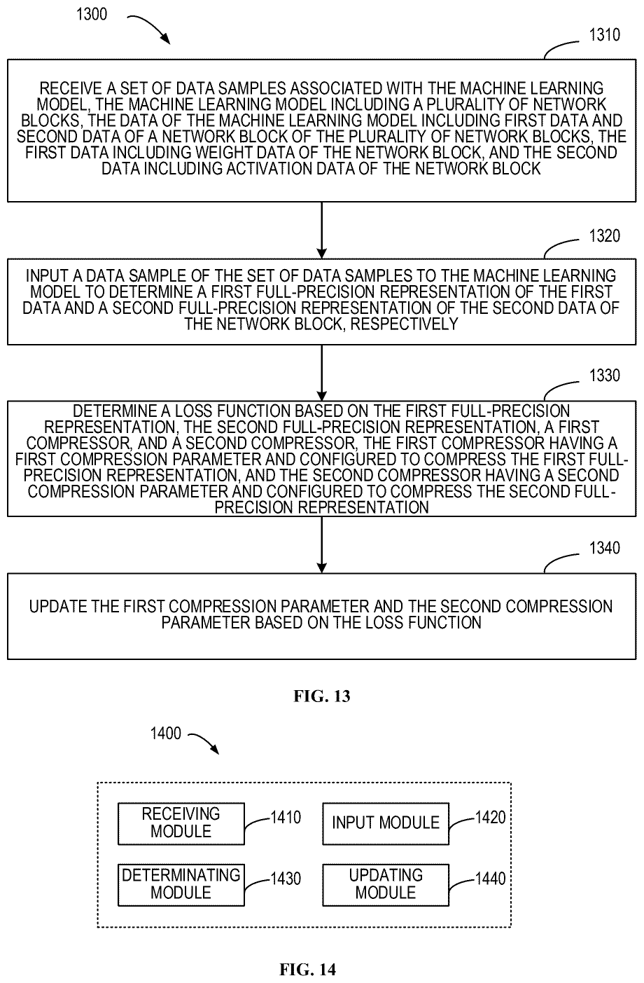

FIG. 13 shows a flowchart of a method 1300 for processing data of a machine learning model according to some implementations of the disclosure. At block 1310, a set of data samples associated with a machine learning model is received. The machine learning model includes a plurality of network blocks, the data of the machine learning model includes first data and second data of a network block of the plurality of network blocks, the first data includes weight data of the network block, and the second data includes activation data of the network block. At block 1320, a data sample of the set of data samples is input to a machine learning model to determine a first full-precision representation of the first data and a second full-precision representation of the second data, respectively, of the network block. At block 1330, a loss function is determined based on the first full-precision representation, the second full-precision representation, a first compressor, and a second compressor. The first compressor has a first compression parameter and is configured to compress the first full-precision representation, and the second compressor has a second compression parameter and is configured to compress the second full-precision representation. At block 1340, the first compression parameter and the second compression parameter are updated based on the loss function.

According to some implementations of the disclosure, the first compressor is determined based on the first compression parameter, a scaling factor, and a first width for indicating a first compressed representation of the first data, and the second compressor is determined based on the second compression parameter, the scaling factor, and a second width for indicating a second compressed representation of the second data.

According to some implementations of the disclosure, determining the loss function includes: determining the first compressed representation based on the first compressor and the first compression parameter, the first compression parameter representing a first clipping range of the first compressor; determining the second compressed representation based on the second compressor and the second compression parameter, the second compression parameter representing a second clipping range of the second compressor; and obtaining the loss function based on the first full-precision representation, the second full-precision representation, the first compressed representation, and the second compressed representation.

According to some implementations of the disclosure, obtaining the loss function includes: determining a full-precision output of the network block based on the first full-precision representation and the second full-precision representation; determining a compressed output of the network block based on the first compressed representation and the second compressed representation; and obtaining the loss function based on a difference between the full-precision output and the compressed output.

According to some implementations of the disclosure, the method 1300 further includes: determining a similarity between a distribution of input data of the network block and a distribution of output data of the network block; determining, in response to determining that the similarity satisfies a predetermined condition, a compensation vector for compensating the output; and updating the output data based on the compensation vector.

According to some implementations of the disclosure, updating the output includes: updating, in response to determining that the network block is a network block of the plurality of network blocks at a head position or a tail position, the output of the network block based on the compensation vector.

According to some implementations of the disclosure, updating the output with the compensation vector includes: updating the weight data of the network block with the compensation vector; and determining the updated output based on the updated weight data.

According to some implementations of the disclosure, updating the first compression parameter and the second compression parameter further includes: determining, for the network block, an attention-aware divergence associated with the network block; and updating the first compression parameter and the second compression parameter based on the attention-aware divergence.

According to some implementations of the disclosure, the method 1300 further includes: setting the network block with the first compression parameter and the second compression parameter; and performing an inference process with the set network block.

According to some implementations of the disclosure, the inference process includes: determining input data of the network block based on a data item to be processed, the input data having a second width, and the weight data of the network block having a first width; dividing the input data into a plurality of input matrices; determining, based on the hardware multiplication instruction of a hardware device implementing the network block, a plurality of multiplication results associated with the plurality of input matrices by using a plurality of thread wraps provided by the hardware device respectively; and determining a result of the inference process based on the plurality of multiplication results.

According to some implementations of the disclosure, determining the plurality of multiplication results respectively includes: for an input matrix of the plurality of input matrices, executing the hardware multiplication instruction with a thread wrap of the plurality of thread wraps to determine a multiplication result associated with the input matrix; and writing the multiplication result into a storage area of the hardware device corresponding to the thread wrap.

According to some implementations of the disclosure, determining the result of the inference process based on the plurality of multiplication results includes: obtaining the plurality of multiplication results from a plurality of storage areas corresponding to the plurality of thread wraps respectively; and determining the result of the inference process based on the plurality of multiplication results.

According to some implementations of the disclosure, dividing the input data into the plurality of input matrices includes: dividing test input data into a first plurality of input matrices and a second plurality of input matrices, respectively, based on parallel configuration information of the hardware device; determining a first performance indicator for performing the inference process based on the first plurality of input matrices, and a second performance indicator for performing the inference process based on the second plurality of input matrices, respectively; and dividing, in response to determining that the first performance indicator is higher than the second performance indicator, the input data into the plurality of input matrices based on a quantity of the first plurality of input matrices.

According to some implementations of the disclosure, the plurality of thread wraps share a plurality of banks in the storage area of the hardware device, and the method 1300 further includes: writing a first input matrix associated with a first thread wrap of the plurality of thread wraps into a first bank of the plurality of banks; padding a bank following the first bank; writing a second input matrix associated with a second thread wrap of the plurality of thread wraps into a second bank following to the bank, no access conflict existing between the first bank and the second bank.

### Example Apparatus and Device

FIG. 14 shows a block diagram of an apparatus 1400 for processing data of a machine learning model according to some implementations of the disclosure. The apparatus 1400 includes: a receiving module 1410 configured to receive a set of data samples associated with the machine learning model, the machine learning model including a plurality of network blocks, the data of the machine learning model including first data and second data of a network block of the plurality of network blocks, the first data including weight data of the network block, and the second data including activation data of the network block; an input module 1420 configured to input a data sample of the set of data samples to the machine learning model to determine a first full-precision representation of the first data and a second full-precision representation of the second data of the network block, respectively; a determining module 1430 configured to determine a loss function based on the first full-precision representation, the second full-precision representation, a first compressor, and a second compressor, the first compressor having a first compression parameter and configured to compress the first full-precision representation, and the second compressor having a second compression parameter and configured to compress the second full-precision representation; and an updating module 1440 configured to update the first compression parameter and the second compression parameter based on the loss function.

According to some implementations of the disclosure, the first compressor is determined based on the first compression parameter, a scaling factor, and a first width for indicating a first compressed representation of the first data, and the second compressor is determined based on the second compression parameter, the scaling factor, and a second width for indicating a second compressed representation of the second data.

According to some implementations of the disclosure, the determining module is further configured to: determine the first compressed representation based on the first compressor and the first compression parameter, the first compression parameter representing a first clipping range of the first compressor; determine the second compressed representation based on the second compressor and the second compression parameter, the second compression parameter representing a second clipping range of the second compressor; and obtain the loss function based on the first full-precision representation, the second full-precision representation, the first compressed representation, and the second compressed representation.

According to some implementations of the disclosure, the determining module is further configured to: determine a full-precision output of the network block based on the first full-precision representation and the second full-precision representation; determine a compressed output of the network block based on the first compressed representation and the second compressed representation; and obtain the loss function based on a difference between the full-precision output and the compressed output.

According to some implementations of the disclosure, a correction module is further included. The correction module is configured to: determine a similarity between a distribution of the input data of the network block and a distribution of output data of the network block; determine, in response to determining that the similarity satisfies a predetermined condition, a compensation vector for compensating the output; and update the output data based on the compensation vector.

According to some implementations of the disclosure, the correction module is further configured to update, in response to determining that the network block is a network block of the plurality of network blocks at a head position or a tail position, the output of the network block based on the compensation vector.

According to some implementations of the disclosure, the correcting module is further configured to: update the weight data of the network block with the compensation vector; and determine the updated output based on the updated weight data.

According to some implementations of the disclosure, the updating module is further configured to: determine, for the network block, an attention-aware divergence associated with the network block; and update the first compression parameter and the second compression parameter based on the attention-aware divergence.

According to some implementations of the disclosure, an inference module is further included. The inference module is configured to: set the network block with the first compression parameter and the second compression parameter; and perform an inference process with the set network block.

According to some implementations of the disclosure, the inference module is further configured to: determine input data of the network block based on a data item to be processed, the input data having a second width, and the weight data of the network block having a first width; divide the input data into a plurality of input matrices; determine, based on a hardware multiplication instruction of a hardware device implementing the network block, a plurality of multiplication results associated with the plurality of input matrices by using a plurality of thread wraps provided by the hardware device respectively; and determine a result of the inference process based on the plurality of multiplication results.

According to some implementations of the disclosure, the inference module is further configured to: for an input matrix of the plurality of input matrices, execute the hardware multiplication instruction with a thread wrap of the plurality of thread wraps to determine a multiplication result associated with the input matrix; and write the multiplication result into a storage area of the hardware device corresponding to the thread wrap.

According to some implementations of the disclosure, the inference module is further configured to: obtain the plurality of multiplication results from a plurality of storage areas corresponding to the plurality of thread wraps respectively; and determine the result of the inference process based on the plurality of multiplication results.

According to some implementations of the disclosure, the inference module is further configured to: divide test input data into a first plurality of input matrices and a second plurality of input matrices, respectively, based on parallel configuration information of the hardware device; determine a first performance indicator for performing the inference process based on the first plurality of input matrices, and a second performance indicator for performing the inference process based on the second plurality of input matrices respectively; and divide, in response to determining that the first performance indicator is higher than the second performance indicator, the input data into the plurality of input matrices based on a quantity of the first plurality of input matrices.

According to some implementations of the disclosure, the plurality of thread wraps share a plurality of banks in the storage area of the hardware device, and the inference module is further configured to: write a first input matrix associated with a first thread wrap of the plurality of thread wraps into a first bank of the plurality of banks; pad a bank following the first bank; write a second input matrix associated with a second thread wrap of the plurality of thread wraps into a second bank following the bank, no access conflict existing between the first bank and the second bank.

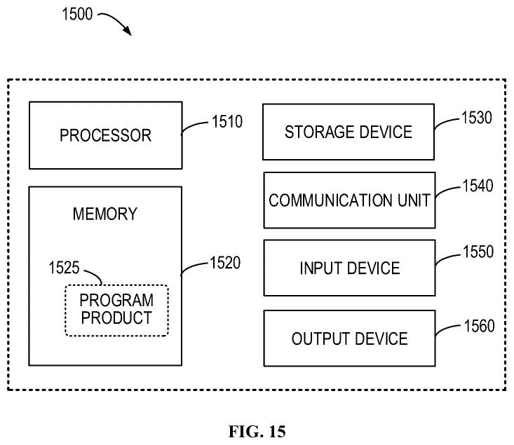

FIG. 15 shows a block diagram of a device 1500 capable of implementing various implementations of the disclosure. It should be understood that a computing device 1500 shown in FIG. 15 is merely illustrative and should not constitute any limitation on the functionality and scope of the implementations described herein. The computing device 1500 shown in FIG. 15 may be configured to implement the method described above.

As shown in FIG. 15, the computing device 1500 is in the form of a general-purpose computing device. Components of the computing device 1500 may include, but are not limited to, one or more processors or processing units 1510, a memory 1520, a storage device 1530, one or more communication units 1540, one or more input devices 1550, and one or more output devices 1560. The processing unit 1510 may be an actual or virtual processor and capable of performing various processes according to programs stored in the memory 1520. In a multiprocessor system, the plurality of processing units executes computer-executable instructions in parallel to improve the parallel processing capability of the computing device 1500.

The computing device 1500 generally includes a plurality of computer storage media. Such media may be any available media accessible by the computing device 1500, including, but not limited to, volatile and non-volatile media, removable and non-removable media. The memory 1520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 1530 may be a removable or non-removable medium and may include a machine-readable medium, such as a flash drive, a magnetic disk, or any other medium, which may be capable of storing information and/or data (e.g., training data for training) and may be accessed within the computing device 1500.

The computing device 1500 may further include additional removable/non-removable, volatile/non-volatile storage media. Although not shown in FIG. 15, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 1520 may include a computer program product 1525 having one or more program modules configured to perform various methods or actions of various implementations of the disclosure.

The communication unit 1540 implements communication with other computing devices through a communication medium. Additionally, the functionality of components of the computing device 1500 may be implemented in a single computing cluster or multiple computing machines capable of communicating through a communication connection. Thus, the computing device 1500 may operate in a networked environment using logical connection(s) with one or more other servers, a network personal computer (PC), or another network node.

The input device 1550 may be one or more input devices such as a mouse, a keyboard, a trackball, or the like. The output device 1560 may be one or more output devices, such as a display, a speaker, a printer, or the like. The computing device 1500 may also communicate with one or more external devices (not shown) as needed, the external device such as a storage device, a display device, etc., communicates with one or more devices that enable a user to interact with the computing device 1500, or communicates with any device (e.g., network card, modem, etc.) that enables the computing device 1500 to communicate with one or more other computing devices. Such communication may be performed via an input/output (I/O) interface (not shown).

According to an example implementation of the disclosure, there is provided a computer-readable storage medium having computer-executable instructions stored thereon, and the computer-executable instructions are executed by a processor to implement the method described above. According to an example implementation of the disclosure, a computer program product is further provided, the computer program product being tangibly stored on a non-transitory computer-readable medium and including computer-executable instructions, the computer-executable instructions are executed by a processor to implement the method described above. According to an example implementation of the disclosure, there is provided a computer program product having stored thereon a computer program, which when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for processing data of a machine learning model, comprising:
receiving a set of data samples associated with the machine learning model, the machine learning model comprising a plurality of network blocks, the data of the machine learning model comprising first data and second data of a network block of the plurality of network blocks, the first data comprising weight data of the network block, and the second data comprising activation data of the network block;
inputting a data sample of the set of data samples to the machine learning model to determine a first full-precision representation of the first data and a second full-precision representation of the second data of the network block, respectively;
determining a loss function based on the first full-precision representation, the second full-precision representation, a first compressor, and a second compressor, the first compressor having a first compression parameter and configured to compress the first full-precision representation, and the second compressor having a second compression parameter and configured to compress the second full-precision representation; and
updating the first compression parameter and the second compression parameter based on the loss function.

2. The method of claim 1, wherein the first compressor is determined based on the first compression parameter, a scaling factor, and a first width for indicating a first compressed representation of the first data, and the second compressor is determined based on the second compression parameter, the scaling factor, and a second width for indicating a second compressed representation of the second data.

3. The method of claim 2, wherein determining the loss function comprises:
determining the first compressed representation based on the first compressor and the first compression parameter, the first compression parameter representing a first clipping range of the first compressor;
determining the second compressed representation based on the second compressor and the second compression parameter, the second compression parameter representing a second clipping range of the second compressor; and
obtaining the loss function based on the first full-precision representation, the second full-precision representation, the first compressed representation, and the second compressed representation.

4. The method of claim 3, wherein obtaining the loss function comprises:
determining a full-precision output of the network block based on the first full-precision representation and the second full-precision representation;
determining a compressed output of the network block based on the first compressed representation and the second compressed representation; and
obtaining the loss function based on a difference between the full-precision output and the compressed output.

5. The method of claim 4, further comprising:
determining a similarity between a distribution of input data of the network block and a distribution of output data of the network block;
determining, in response to determining that the similarity satisfies a predetermined condition, a compensation vector for compensating the output; and
updating the output data based on the compensation vector.

6. The method of claim 5, wherein updating the output comprises: updating, in response to determining that the network block is a network block of the plurality of network blocks at a head position or a tail position, the output of the network block based on the compensation vector.

7. The method of claim 5, wherein updating the output with the compensation vector comprises:
updating the weight data of the network block with the compensation vector; and
determining the updated output based on the updated weight data.

8. The method of claim 1, wherein updating the first compression parameter and the second compression parameter further comprises:
determining, for the network block, an attention-aware divergence associated with the network block; and
updating the first compression parameter and the second compression parameter based on the attention-aware divergence.

9. The method of claim 1, further comprising:
setting the network block with the first compression parameter and the second compression parameter; and
performing an inference process with the set network block.

10. The method of claim 9, wherein performing the inference process comprises:
determining input data of the network block based on a data item to be processed, the input data having a second width, and the weight data of the network block having a first width;
dividing the input data into a plurality of input matrices;
determining, based on a hardware multiplication instruction of a hardware device implementing the network block, a plurality of multiplication results associated with the plurality of input matrices by using a plurality of thread wraps provided by the hardware device respectively; and
determining a result of the inference process based on the plurality of multiplication results.

11. The method of claim 10, wherein determining the plurality of multiplication results respectively comprises: for an input matrix of the plurality of input matrices, executing the hardware multiplication instruction with a thread wrap of the plurality of thread wraps to determine a multiplication result associated with the input matrix; and
writing the multiplication result into a storage area of the hardware device corresponding to the thread wrap.

12. The method of claim 11, wherein determining the result of the inference process based on the plurality of multiplication results comprises:
obtaining the plurality of multiplication results from a plurality of storage areas corresponding to the plurality of thread wraps respectively; and
determining the result of the inference process based on the plurality of multiplication results.

13. The method of claim 11, wherein dividing the input data into the plurality of input matrices comprises:
dividing test input data into a first plurality of input matrices and a second plurality of input matrices, respectively, based on parallel configuration information of the hardware device;
determining a first performance indicator for performing the inference process based on the first plurality of input matrices, and a second performance indicator for performing the inference process based on the second plurality of input matrices, respectively; and
dividing, in response to determining that the first performance indicator is higher than the second performance indicator, the input data into the plurality of input matrices based on a quantity of the first plurality of input matrices.

14. The method of claim 11, wherein the plurality of thread wraps share a plurality of banks in the storage area of the hardware device, and the method further comprises:
writing a first input matrix associated with a first thread wrap of the plurality of thread wraps into a first bank of the plurality of banks;
padding a bank following the first bank;
writing a second input matrix associated with a second thread wrap of the plurality of thread wraps into a second bank following the bank, no access conflict existing between the first bank and the second bank.

15. An electronic device, comprising:
at least one processor; and
at least one memory coupled to the at least one processor and storing instructions for execution by the at least one processor, the instructions, when executed by the at least one processor, causing the electronic device to perform acts comprising:
receiving a set of data samples associated with the machine learning model, the machine learning model comprising a plurality of network blocks, the data of the machine learning model comprising first data and second data of a network block of the plurality of network blocks, the first data comprising weight data of the network block, and the second data comprising activation data of the network block;
inputting a data sample of the set of data samples to the machine learning model to determine a first full-precision representation of the first data and a second full-precision representation of the second data of the network block, respectively;
determining a loss function based on the first full-precision representation, the second full-precision representation, a first compressor, and a second compressor, the first compressor having a first compression parameter and configured to compress the first full-precision representation, and the second compressor having a second compression parameter and configured to compress the second full-precision representation; and
updating the first compression parameter and the second compression parameter based on the loss function.

16. The electronic device of claim 15, wherein the first compressor is determined based on the first compression parameter, a scaling factor, and a first width for indicating a first compressed representation of the first data, and the second compressor is determined based on the second compression parameter, the scaling factor, and a second width for indicating a second compressed representation of the second data.

17. The electronic device of claim 15, wherein the acts further comprise:
setting the network block with the first compression parameter and the second compression parameter; and
performing an inference process with the set network block.

18. The electronic device of claim 17, wherein performing the inference process comprises:
determining input data of the network block based on a data item to be processed, the input data having a second width, and the weight data of the network block having a first width;
dividing the input data into a plurality of input matrices;
determining, based on a hardware multiplication instruction of a hardware device implementing the network block, a plurality of multiplication results associated with the plurality of input matrices by using a plurality of thread wraps provided by the hardware device respectively; and
determining a result of the inference process based on the plurality of multiplication results.

19. The electronic device of claim 18, wherein determining the plurality of multiplication results respectively comprises: for an input matrix of the plurality of input matrices, executing the hardware multiplication instruction with a thread wrap of the plurality of thread wraps to determine a multiplication result associated with the input matrix; and
writing the multiplication result into a storage area of the hardware device corresponding to the thread wrap.

20. A non-transitory computer-readable storage medium having a computer program stored thereon, wherein the computer program, when executed by a processor, causes the processor to perform acts comprising:
receiving a set of data samples associated with the machine learning model, the machine learning model comprising a plurality of network blocks, the data of the machine learning model comprising first data and second data of a network block of the plurality of network blocks, the first data comprising weight data of the network block, and the second data comprising activation data of the network block;
inputting a data sample of the set of data samples to the machine learning model to determine a first full-precision representation of the first data and a second full-precision representation of the second data of the network block, respectively;
determining a loss function based on the first full-precision representation, the second full-precision representation, a first compressor, and a second compressor, the first compressor having a first compression parameter and configured to compress the first full-precision representation, and the second compressor having a second compression parameter and configured to compress the second full-precision representation; and
updating the first compression parameter and the second compression parameter based on the loss function.
